(19) United States
(12) Patent Application Publication
(10) Pub. No.: US 2006/0035536 A1
(43) Pub. Date: Feb. 16, 2006

(54) Electrical connector

(76) Inventor: Noriaki Sai, Kanagawa (JP)

Correspondence Address: BARLEY SNYDER, LLC, 1000 WESTLAKES DRIVE, SUITE 275, BERWYN, PA, 19312, US

(21) Appl. No.: 11/203,056

(22) Filed: Aug. 12, 2005

(30) Foreign Application Priority Data
Aug. 13, 2004 (JP) 2004-236107

(51) Int. Cl. H01R 13/514

(52) U.S. Cl. 439/752

(57) ABSTRACT

An electrical connector comprises an insulating housing having contact receiving openings that receive contacts. Housing lances extend into the contact receiving openings and engage the contacts to perform a primary locking function of the contacts. A retainer is mounted to a front surface of the housing. The retainer has tool insertion openings communicating with the contact receiving openings. The retainer is moveable between a temporary locking position and a main locking position. The retainer is locked to the housing in both the temporary locking position where the contacts are insertable into the housing and the main locking position where the retainer performs a secondary locking function of the contacts.

### FIELD OF THE INVENTION

The invention relates to an electrical connector having a housing comprising a retainer that performs a secondary locking function of contacts arranged in the housing.

### BACKGROUND OF THE INVENTION

Electrical connectors having a double locking function are widely used in automobiles in order to ensure or strengthen the locking of contacts with respect to a housing of the electrical connector. In automotive applications, since the electrical connector is subjected to vibration, reliability of the locking of the contacts with respect to the housing is important. The double locking function involves not only performing primary locking of the contacts by means of housing lances that extend from inner walls of the housing into contact receiving openings, but also secondary locking of the contacts by a retainer that is separate from the housing.

One example of such an electrical connector is described in Japanese Patent Application Kokai No. H4-137474 and shown in FIGS. 14A-14B. As shown in FIGS. 14A-14B, the electrical connector 101 comprises an insulating housing 110, a plurality of contacts 120 accommodated in a plurality of contact receiving openings 111 provided in the housing 110, and a retainer 130 for performing a secondary locking function of the contacts 120. A housing lance 112 extends into each of the contact receiving openings 111 from an upper wall of the contact receiving openings 111. The housing lances 112 are designed to perform a primary locking function of the contacts 120 accommodated inside the contact receiving openings 111.

The retainer 130 is attached to the housing 110 from a bottom surface of the housing 110 facing upward and is locked to the housing 110 in a temporary locking position shown in FIG. 14A. In the temporary locking position, insertion of the contacts 120 into the contact receiving openings 111 is possible. In a main locking position shown in FIG. 14B, the secondary locking function of the contacts 120 is performed.

The contacts 120 are inserted into the contact receiving openings 111 from a rear side (right side in FIG. 14A) of the housing 110 when the retainer 130 is temporarily locked in the temporary locking position, as shown in FIG. 14A. The primary locking function of the contacts 120 is performed by the housing lances 112. When the retainer 130 is locked in the main locking position shown in FIG. 14B following the primary locking of the contacts 120, the secondary locking function of the contacts 120 is performed by the retainer 130, so that the locking of the contacts 120 with respect to the housing 110 is ensured or strengthened.

However, in the electrical connector 101 comprising the retainer 130, since the retainer 130 is attached to the housing 110 from the bottom surface of the housing 110, it is necessary to form an opening 131 for accommodation of the retainer 130 in the housing 110 from the bottom surface of the housing 110 toward a top surface of the housing 110 and substantially over the entire area of the housing 110 in a direction of width (direction perpendicular to the plane of the page in FIG. 14A). Consequently, the contact receiving openings 111 cannot be formed independently, which results in poor waterproofing characteristics. This electrical connector 101 therefore is not waterproof.

Another type of electrical connector is described in Japanese Utility Model Application Kokai No. H3-20880 and shown in FIG. 15. The electrical connector 201 comprises a retainer that is inserted from a front surface of an insulating housing 210 that performs a secondary locking function. The electrical connector 201 comprises the housing 210, a plurality of contacts 220 accommodated in a plurality of contact accommodating openings 211 provided in the housing 210, and the retainer 230 that is inserted from the front surface (right surface in FIG. 15) of the housing 210 that performs the secondary locking function of the contacts 220.

Each of the contact accommodating openings 211 in the housing 210 is provided with a housing lance 212 that extends forward from an upper wall of each of the contact receiving openings 211. A housing lance receiving space 213 formed substantially above each of the housing lances 212 allows for deflection of each of the housing lances 212. The housing lances 212 are designed to serve a primary locking function of the contacts 220 accommodated inside the contact receiving openings 211.

The retainer 230 is constructed to be inserted from the front surface of the housing 210 and is locked to the housing 210 in a temporary locking position (not shown) in which the insertion of the contacts 220 into the contact receiving openings 211 is possible and in a main locking position shown in FIG. 15 in which the secondary locking function of the contacts 220 is performed.

The contacts 220 are inserted into the contact receiving openings 211 from a rear side (left side in FIG. 15) of the housing 210 when the retainer 230 is temporarily locked in the temporary locking position and the primary locking function of the contacts 220 is performed by the housing lances 212. When the retainer 230 is locked in the main locking position shown in FIG. 15 following the primary locking of the contacts 220, restriction members 231 of the retainer 230 enter the housing lance receiving spaces 213 and restrict the deflection of the housing lances 212. As a result, the secondary locking function of the contacts 220 is performed by the retainer 230, so that the locking of the contacts 220 with respect to the housing 210 is ensured or strengthened. Furthermore, the electrical connector 201 is designed to mate with a housing 251 of a mating connector 250, so that the contacts 220 make contact with terminals 252 provided on the mating connector 250.

There are cases in which the contacts 120, 220 of the electrical connectors 101, 201 are erroneously inserted into the electrical connectors 101, 201. When such erroneous insertion of the contacts 120, 220 occurs, a problem exists in that circuits are not properly connected to the contacts 120, 220. It is therefore necessary to replace the erroneously inserted contacts 120, 220. The erroneous insertion of the contacts 120, 220 is often discovered when a circuit inspection is performed by a checker following the secondary locking function of the contacts 120, 220. Additionally, in cases where the contacts 120, 220 are damaged, even if the contacts 120, 220 are not erroneously inserted, it becomes necessary to remove the contacts 120, 220 from the housings 110, 210 so that the contacts 120, 220 can be replaced.

To replace the contacts 120, 220 in the electrical connector 101 comprising the retainer 130 shown in FIGS. 14A-14B, the state of the secondary locking function of the contacts 120 is released by removing the retainer 130 from the housing 110. A tool (not shown) is then inserted into an opening formed in the front surface of the housing 110 to cause the housing lances 112 to deflect upward and release the primary locking function of the contacts 120 so that the contacts 120 can be pulled-out toward the rear of the housing 110.

In the electrical connector 201 comprising the retainer 230 shown in FIG. 15, the secondary locking function of the contacts 220 is released by removing the retainer 230 from the front of the housing 210. A tool (not shown) is then inserted into an opening formed in the front surface of the housing 210 to cause the housing lances 212 that are performing the primary locking function of the contacts 220 to deflect upward so that the primary locking function of the contacts 220 is released. The contacts 220 are pulled-out toward the rear of the housing 210. In this case, since the number of locations where the retainer 230 is locked to the housing 210 is large, the retainer 230 cannot easily be removed from the housing 210. Accordingly, it is difficult to remove the contacts 220 from the housing 210.

### SUMMARY OF THE INVENTION

It is therefore an object of the invention to provide an electrical connector with a retainer that performs a secondary locking function wherein contacts can be removed from the housing without removing the retainer from the housing.

This and other objects are achieved by an electrical connector comprising an insulating housing having contact receiving openings for receiving contacts. Housing lances extend into the contact receiving openings and perform a primary locking function of the contacts. A retainer is mounted to a front surface of the housing. The retainer has tool insertion openings communicating with the contact receiving openings. The retainer is moveable between a temporary locking position and a main locking position. The retainer is locked to the housing in both the temporary locking position where the housing lances perform the primary locking function of the contacts and the main locking position where the retainer performs a secondary locking function of the contacts.

This and other objects are further achieved by an electrical connector comprising an insulating housing having contact receiving openings that receive contacts. Housing lances extend into the contact receiving openings and engage the contacts to perform a primary locking function of the contacts. A retainer is mounted to a front surface of the housing. The retainer has tool insertion openings communicating with the contact receiving openings. The retainer is moveable between a temporary locking position and a main locking position. The retainer is locked to the housing in both the temporary locking position where the contacts are insertable into the housing and the main locking position where the retainer performs a secondary locking function of the contacts.

### BRIEF DESCRIPTION OF THE DRAWINGS

FIG. 1 is a front view of an electrical connector according to the invention showing a retainer in a temporary locking position;

FIG. 2 is a sectional view along line 2-2 of FIG. 1;

FIG. 3 is a sectional view along line 3-3 of FIG. 1;

FIG. 4 is a sectional view along line 4-4 of FIG. 1;

FIG. 5 is a sectional view along line 5-5 of FIG. 1;

FIG. 6 is a sectional view along line 6-6 of FIG. 4;

FIG. 7 is a front view of the electrical connector showing the retainer in a main locking position;

FIG. 8 is a sectional view along line 8-8 of FIG. 7;

FIG. 9 is a sectional view along line 9-9 of FIG. 7;

FIG. 10 is a sectional view along line 10-10 of FIG. 7;

FIG. 11 is a sectional view along line 11-11 of FIG. 7;

FIG. 12 is a sectional view along line 12-12 of FIG. 10;

FIG. 13 is a perspective view of the retainer;

FIG. 14A is a sectional view of a conventional electrical connector shown with a retainer in a temporary locking position;

FIG. 14B is a sectional view of the conventional electrical connector shown with the retainer in a main locking position; and

FIG. 15 is a sectional view of another conventional electrical connector comprising a retainer.

### DETAILED DESCRIPTION OF THE INVENTION

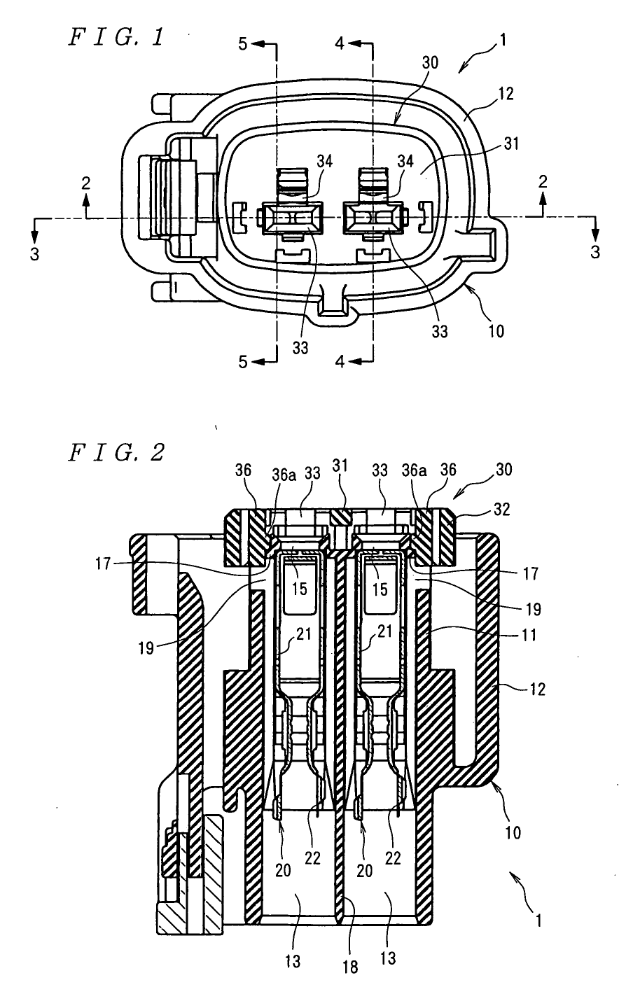

FIGS. 1-13 show an electrical connector 1. As shown in FIGS. 1-2, the electrical connector 1 comprises an insulating housing 10 and a retainer 30. A plurality of contacts 20 are arranged, for example, in a single row in the housing 10. The retainer 30 performs a secondary locking function of the contacts 20.

The housing 10 has a substantially rectangular shape and may be formed, for example, by molding an insulating synthetic resin. The housing 10 includes a contact accommodating member 11. A hood 12 extends from the contact accommodating member 11 and covers the contact accommodating member 11. A waterproofing seal (not shown) is provided around the contact accommodating member 11. The contact accommodating member 11 has a plurality of contact receiving openings 13 formed, for example, in a single row. As shown in FIG. 4, the contact receiving openings 13 open toward a rear side of the housing 10. Mating contact insertion openings 15 are formed on a front side of the contact receiving openings 13. As shown in FIGS. 2, 3, and 6, a partition wall 18 divides adjacent contact receiving openings 13 so that each of the contact receiving openings 13 are independent from each other. Accordingly, it is possible to increase the waterproofing characteristics of the electrical connector 1.

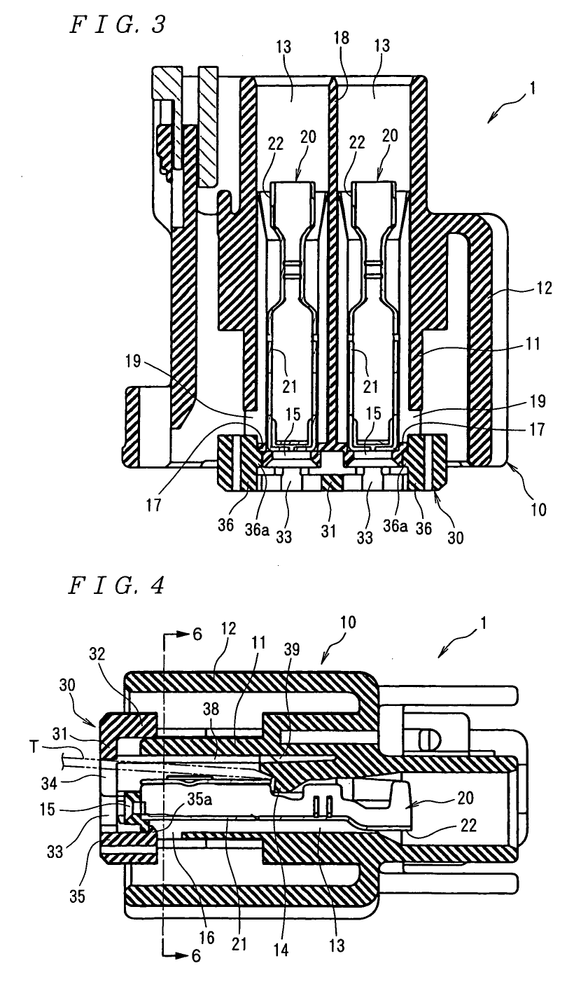

As is shown in FIG. 4, a first locking aperture 16 is formed on a front side of a bottom wall of each of the contact receiving openings 13. As shown in FIGS. 2-3, a second locking aperture 19 is formed on a front side of the outer wall of each of the contact receiving openings 13. Locking projections 17 are formed on a front side of the second locking apertures 19.

As shown in FIG. 4, housing lances 14 extend into the contact receiving openings 13 and perform a primary locking function of the contacts 20. The housing lances 14 extend forward slightly at an inclination from an upper wall of the contact accommodating member 11. Housing lance receiving spaces 39 are formed between the upper wall and the housing lances 39 for receiving the housing lances 14 when the housing lances 14 are deflected.

Each of the contacts 20 is formed, for example, by stamping and forming a metal plate and comprises a substantially box-shaped receptacle 21, as shown in FIG. 4. An electrical wire connecting member 22 extends rearward from the receptacle 21 and is connected by crimping to an electrical wire (not shown).

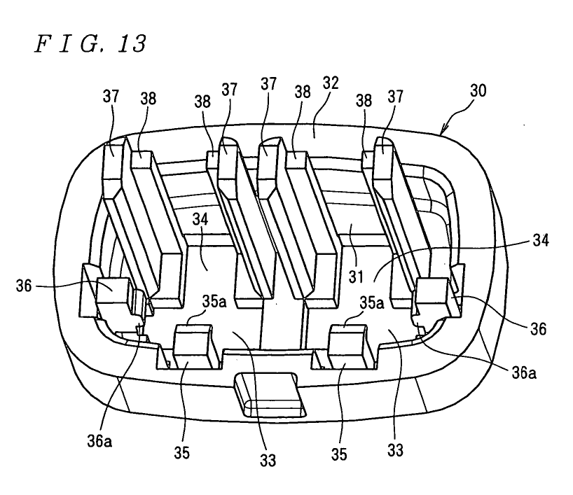

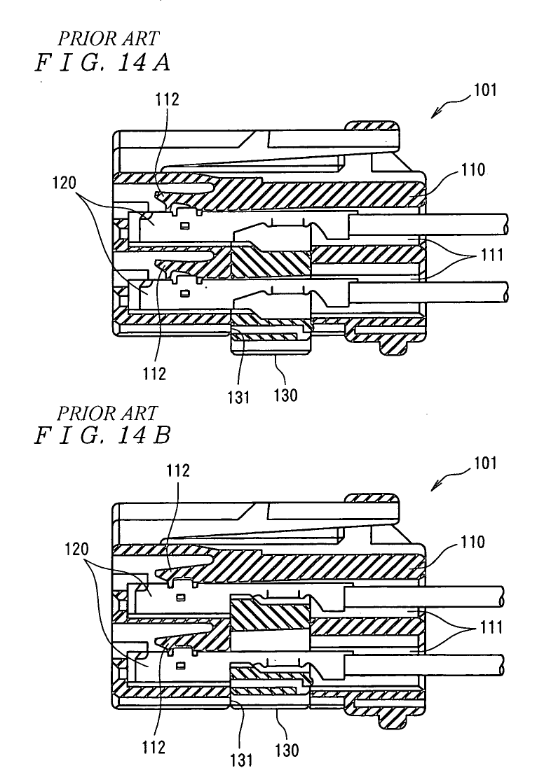

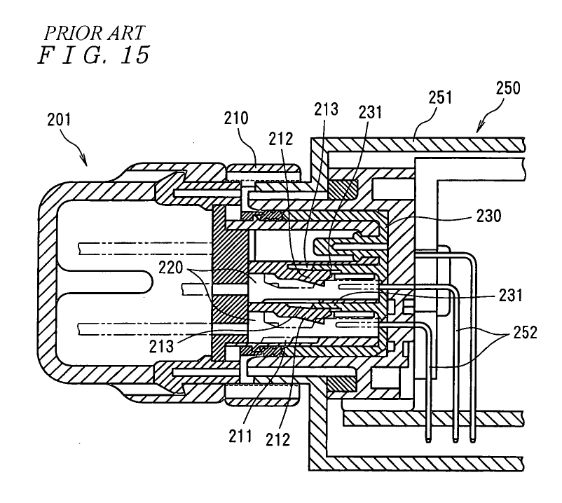

The retainer 30 may be formed, for example, by molding an insulating synthetic resin. As shown in FIG. 4, the retainer 30 comprises a substantially rectangular flat base plate 31 configured to cover the front surface of the contact accommodating member 11 of the housing 10. As shown in FIG. 13, a frame 32 extends rearward from the base plate 31 and surrounds a periphery of the base plate 31. A plurality of substantially rectangular contact insertion openings 33 are formed, for example, in a single row in the base plate 31 in positions corresponding to the contact receiving openings 13.

Tool insertion openings 34 are formed substantially above the contact insertion openings 33. The tool insertion openings 34 communicate with the contact insertion openings 33. Each of the tool insertion openings 34 is formed with a substantially rectangular shape and has a width smaller than the contact insertion openings 33. Each of the tool insertion openings 34 has a vertical position corresponding to the vertical position of the housing lances 14, as shown in FIG. 4.

As shown in FIG. 13, a temporary locking member 35 extends rearward beneath each of the contact insertion openings 33 and is formed as a cantilever. A temporary locking projection 35a protrudes upward from an end of each of the temporary locking members 35. Main locking members 36 extend rearward from an outside of the contact insertion openings 33. Main locking projections 36a protrude inward from central portions of the main locking members 36 in a forward-rearward direction. A pair of secondary locking members 38 extends rearward as plate-form bodies from either side of each of the tool insertion openings 34 in positions corresponding to upper ends of the tool insertion openings 34. Supporting walls 37 extend rearward from an outside of each of the secondary locking members 38.

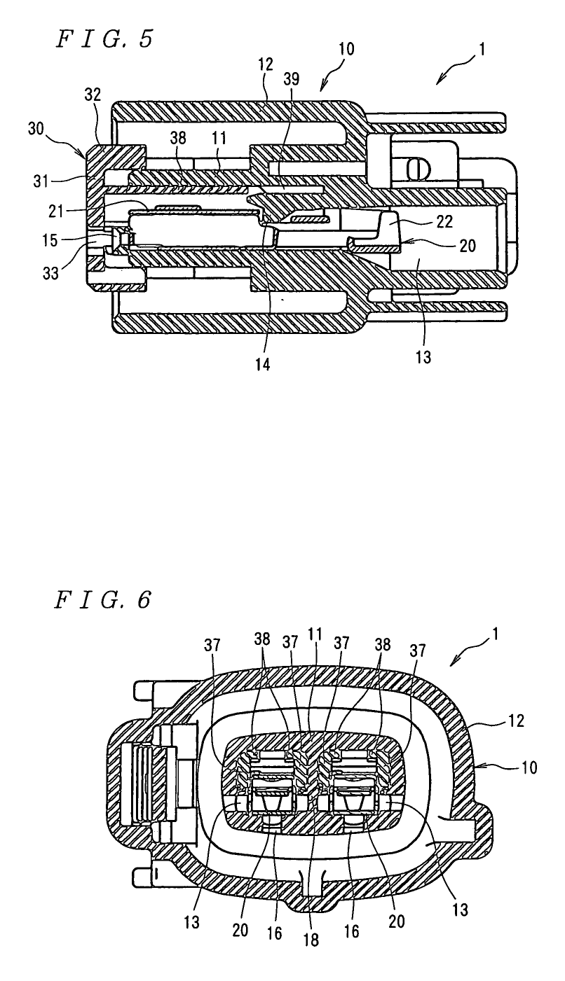

A method for assembling the electrical connector 1 will now be described. To assemble the electrical connector 1, the retainer 30 is inserted from the front surface of the housing 10 into a temporary locking position shown in FIGS. 1-6. In the temporary locking position, the temporary locking projections 35a of the retainer 30 enter the first locking apertures 16 in the housing 10, so that the retainer 30 is prevented from being pulled-out toward the front of the housing 10. As shown in FIG. 3, the main locking projections 36a are positioned on the front side of the locking projections 17 of the housing 10, thus preventing the retainer 30 from being pushed in further toward the rear of the housing 10. As shown in FIG. 5, when the retainer 30 is in the temporary locking position, the secondary locking members 38 are positioned inside the contact receiving openings 13 and are positioned in front of the housing lance receiving spaces 39. Accordingly, the housing lances 14 can deflect into the housing lance receiving spaces 39, so that it is possible to insert the contacts 20 into the contact receiving openings 13 from the rear of the housing 10. The housing lances 14 are positioned on the rear side of the receptacles 21 of the contacts 20, so that the contacts 20 are prevented from slipping out of the housing 10 and the primary locking function of the contacts 20 is performed. As shown in FIG. 6, the supporting walls 37 of the retainer 30 support both sides of the receptacles 21 of the contacts 20.

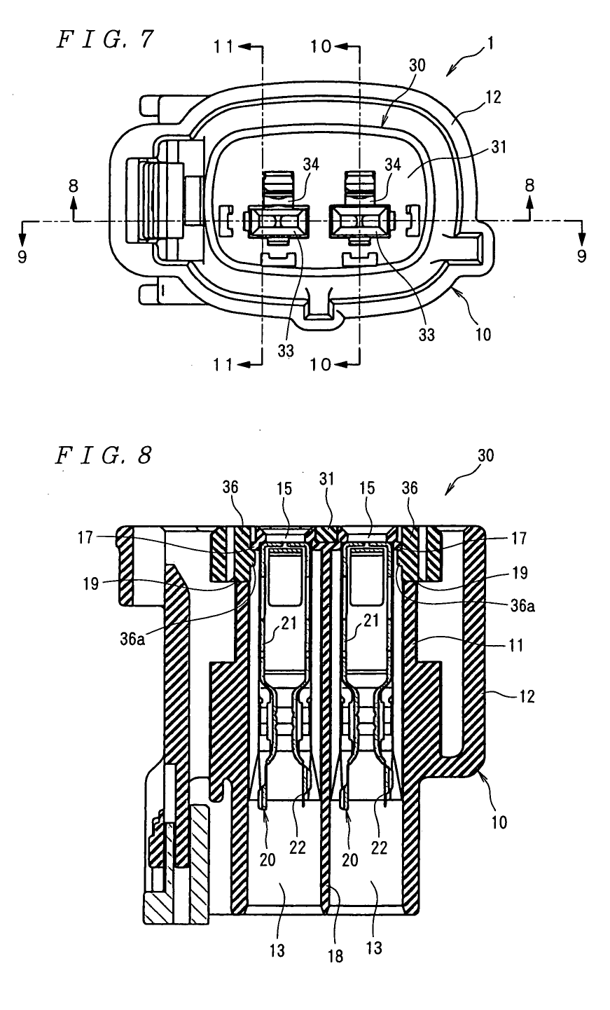

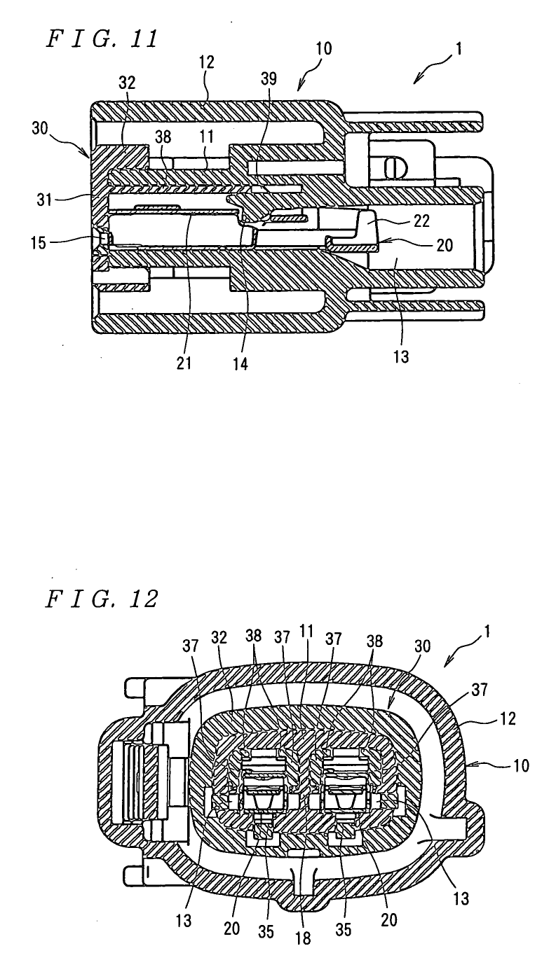

After insertion of the contacts 20, the retainer 30 that is in the temporary locking position is pushed rearward so that the retainer 30 is positioned in the main locking position shown in FIGS. 7-12. While the supporting walls 37 of the retainer 30 support both sides of the receptacle parts 21 of the contacts 20, as shown in FIG. 12, the secondary locking members 38 of the retainer 30 advance into the housing lance receiving spaces 39 and restrict the deflection of the housing lances 14 into the housing lance receiving spaces 39, thus accomplishing the secondary locking function of the contacts 20, as shown in FIG. 11. Since the secondary locking members 38 are provided on both sides of the tool insertion openings 34, it is possible to securely hold the contacts 20 in the housing 10 and prevent rattling. The supporting walls 37 support both sides of the receptacles 21 of the contacts 20 when the retainer 30 is in the main locking position, as shown in FIG. 12.

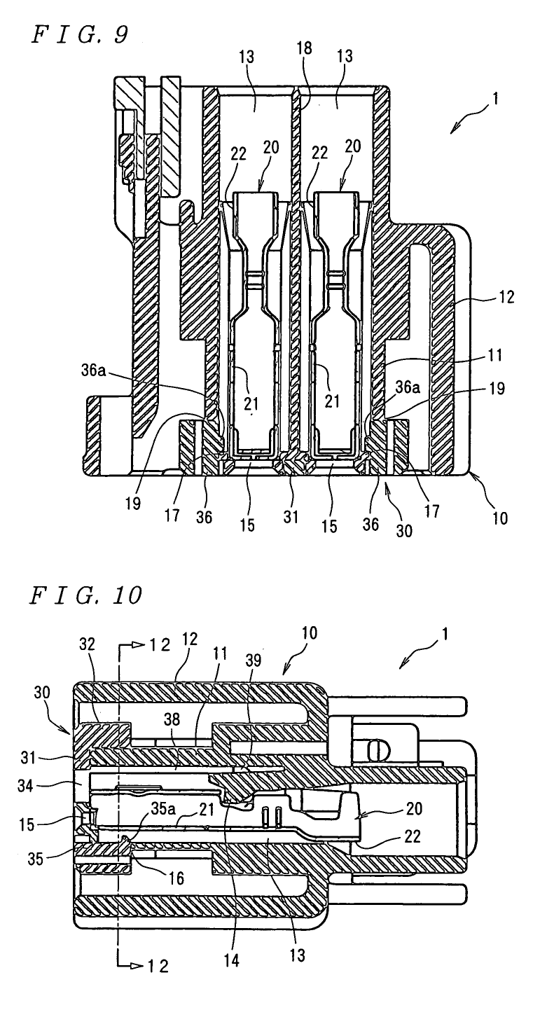

As shown in FIGS. 8-9, when the retainer 30 is in the main locking position, the main locking projections 36a enter the second locking openings 19 in the housing 10 and are positioned behind the locking projections 17, thus preventing the retainer 30 from being pulled-out toward the front of the housing 10. Moreover, when the retainer 30 is in the main locking position, rear ends of the main locking members 36 contact rear ends of the second locking apertures 19, so that rearward movement of the retainer 30 is restricted. As a result, the assembly of the electrical connector 1 is completed, and a mating contact (not shown) is inserted into each of the receptacles 21 and makes connection therewith.

When the need to replace the contacts 20 arises following completion of the assembly of the electrical connector 1 due, for example, to the erroneous insertion of the contacts 20, damage to the contacts 20, or the like, the retainer 30 is returned to the temporary locking position shown in FIGS. 1-6 from the main locking position shown in FIGS. 7-12. The main locking members 36 are caused to flex outward so that the main locking projections 36a are positioned in front of the locking projections 17, and the secondary locking members 38 are positioned away from the housing lance receiving spaces 39. As shown in FIG. 4, a specified tool T for operating one of the housing lances 14 is passed through the tool insertion opening 34 from the front side of the retainer 30. A tip of the tool T causes the housing lance 14 to deflect into the housing lance receiving spaces 39 to releasing the primary locking function of the contact 20. As a result, the contact 20 can be pulled-out toward the rear of the housing 10 without removing the retainer 30 from the housing 10.

In the electrical connector 1, since the tool insertion openings 34 are formed in the retainer 30, it is possible to operate the housing lances 14 that perform the primary locking of the contacts 20 by passing the tool T the tool insertion opening 34 from the front side of the retainer 30 in a state in which the retainer 30 is locked to the housing in the temporary locking position. Accordingly, the contacts 20 can be removed from the housing 10 without removing the retainer 30. In addition, the secondary locking members 38 are provided on the retainer 30 on both sides of the tool insertion openings 34, so that it is possible to securely hold the contacts 20 without rattling. Because the electrical connector 1 is waterproof, it is also suitable for an automobile when there is a progressive increase of voltage of electrical components, for example, from 12 V to 42 V, therein.

The foregoing illustrates some of the possibilities for practicing the invention. Many other embodiments are possible within the scope and spirit of the invention. For example, in the illustrated embodiment, the number of the tool insertion openings 34 formed in the retainer 30 corresponds to the number of the contact insertion openings 33, however, any number of the tool insertion openings 34 can be provided. Additionally, the secondary locking members 38 do not have to be provided on both sides of the tool insertion openings 34. It is, therefore, intended that the foregoing description be regarded as illustrative rather than limiting, and that the scope of the invention is given by the appended claims together with their full range of equivalents.

I/We claim:

1. An electrical connector, comprising:
an insulating housing having contact receiving openings for receiving contacts;
housing lances extending into the contact receiving openings, the housing lances performing a primary locking function of the contacts; and
a retainer mounted to a front surface of the housing, the retainer having tool insertion openings communicating with the contact receiving openings, the retainer being moveable between a temporary locking position and a main locking position, the retainer being locked to the housing in both the temporary locking position where the housing lances perform the primary locking function of the contacts and the main locking position where the retainer performs a secondary locking function of the contacts.

2. The electrical connector of claim 1, wherein the retainer includes contact insertion openings corresponding to the contact receiving openings.

3. The electrical connector of claim 1, wherein the housing lances are deflectable into housing lance receiving spaces when the retainer is in the temporary locking position.

4. The electrical connector of claim 3, wherein the retainer includes secondary locking members that extend into the housing lance receiving spaces when the retainer is in the main locking position to prevent deflection of the housing lances.

5. The electrical connector of claim 4, wherein the secondary locking members extend from both sides of each of the tool insertion openings.

6. The electrical connector of claim 4, wherein the secondary locking members include supporting walls for supporting the contacts.

7. The electrical connector of claim 1, wherein the contact receiving openings are formed in a single row.

8. The electrical connector of claim 1, wherein the retainer is formed from an insulating material.

9. The electrical connector of claim 1, wherein the housing includes partition walls formed between each of the contact receiving openings.

10. An electrical connector, comprising:
an insulating housing having contact receiving openings that receive contacts;
housing lances extending into the contact receiving openings that engage the contacts to perform a primary locking function of the contacts; and
a retainer mounted to a front surface of the housing, the retainer having tool insertion openings communicating with the contact receiving openings, the retainer being moveable between a temporary locking position and a main locking position, the retainer being locked to the housing in both the temporary locking position where the contacts are insertable into the housing and the main locking position where the retainer performs a secondary locking function of the contacts.

11. The electrical connector of claim 10, wherein the retainer includes contact insertion openings corresponding to the contact receiving openings.

12. The electrical connector of claim 10, wherein the housing lances are deflectable into housing lance receiving spaces when the retainer is in the temporary locking position.

13. The electrical connector of claim 12, wherein the retainer includes secondary locking members that extend into the housing lance receiving spaces when the retainer is in the main locking position to prevent deflection of the housing lances.

14. The electrical connector of claim 13, wherein the secondary locking members extend from both sides of each of the tool insertion openings.

15. The electrical connector of claim 13, wherein the secondary locking members include supporting walls that support the contacts.

16. The electrical connector of claim 13, wherein the supporting walls support the contacts in the temporary locking position and the main locking position.

17. The electrical connector of claim 10, wherein the contact receiving openings are formed in a single row.

18. The electrical connector of claim 10, wherein the retainer is formed from an insulating material.

19. The electrical connector of claim 10, wherein the housing includes partition walls formed between each of the contact receiving openings.
